(19) United States
(12) Patent Application Publication
(10) Pub. No.: US 2019/0296388 A1
(43) Pub. Date: Sep. 26, 2019

(54) BATTERY CELL FOR ELECTRIC VEHICLE BATTERY PACK

(71) Applicant: SF Motors, Inc., Santa Clara, CA (US)

(72) Inventors: Chien-Fan Chen, Santa Clara, CA (US); Ying Liu, Santa Clara, CA (US)

(21) Appl. No.: 16/153,150

(22) Filed: Oct. 5, 2018

Related U.S. Application Data
(60) Provisional application No. 62/646,986, filed on Mar. 23, 2018.

(51) Int. Cl. H01M 10/0525; H01M 10/02; H01M 10/04; H01M 10/0585; H01M 10/0565; H01M 2/02

(52) U.S. Cl. CPC H01M 10/0525; H01M 10/02; H01M 2/024; H01M 10/0585; H01M 10/0565; H01M 10/0468

(57) ABSTRACT

Provided herein is a battery cell of a battery pack to power an electric vehicle. The battery cell can include a housing having a first end and a second end and defining an inner region. The battery cell can include a lid that includes a first polarity portion, a second polarity portion and a first isolation layer between the first polarity portion and the second polarity portion. The second polarity portion can be coupled with the first end of the housing. The battery cell can include an electrolyte disposed in the inner region defined by the housing and a first polarity tab that electrically couples the electrolyte with the first polarity portion of the lid. The first polarity tab can include a spring element. The spring element can be configured to apply a force at a predetermined level to the electrolyte.

### RELATED APPLICATION

The present application claims the benefit of priority under 35 U.S.C. § 119(e) to U.S. Provisional Application 62/646,986, filed on Mar. 23, 2018, titled “BATTERY CELL FOR ELECTRIC VEHICLE BATTERY PACK,” which is incorporated herein by reference in its entirety.

### BACKGROUND

Batteries can include electrochemical materials to supply electrical power to various electrical components connected thereto. Such batteries can provide electrical energy to various electrical systems.

### SUMMARY

At least one aspect is directed to a battery cell of a battery pack to power an electric vehicle. The battery cell can include a housing having a first end and a second end and defining an inner region. The battery cell can include a lid that includes a first polarity portion, a second polarity portion and a first isolation layer between the first polarity portion and the second polarity portion. The second polarity portion can couple with the first end of the housing. The battery cell can include an electrolyte disposed in the inner region defined by the housing. The battery cell can include a first polarity tab that electrically couples the electrolyte with the first polarity portion of the lid. The first polarity tab can include a spring element. The spring element that applies a force to the electrolyte.

At least one aspect is directed to a method of providing battery cells for battery packs to power an electric vehicle. The method can include providing a battery pack having a battery cell. The battery call can include a housing that includes a first end and a second end and defining an inner region. The method can include disposing an electrolyte in the inner region defined by the housing. The method can include coupling a lid to the first end of the housing. The lid can include a first polarity portion, a second polarity portion and a first isolation layer disposed between the first polarity portion and the second polarity portion. The second polarity portion can couple with the first end of the housing. The method can include electrically coupling, through a first polarity tab, the electrolyte with the first polarity portion of the lid. The first polarity tab can include a spring element to apply a force at a predetermined level to the electrolyte.

At least one aspect is directed to a method. The method can include providing at least one battery cell for at least one battery pack to power an electric vehicle. The battery cell can include a housing having a first end and a second end and defining an inner region. The battery cell can include a lid that includes a first polarity portion, a second polarity portion and a first isolation layer between the first polarity portion and the second polarity portion. The second polarity portion can couple with the first end of the housing. The battery cell can include an electrolyte disposed in the inner region defined by the housing. The battery cell can include a first polarity tab that electrically couples the electrolyte with the first polarity portion of the lid. The first polarity tab can include a spring element. The spring element that applies a force to the electrolyte.

At least one aspect is directed to an electric vehicle. The electric vehicle can include a battery cell of a battery pack to power electric vehicles. The battery cell can include a housing having a first end and a second end and defining an inner region. The battery cell can include a lid that includes a first polarity portion, a second polarity portion and a first isolation layer between the first polarity portion and the second polarity portion. The second polarity portion can couple with the first end of the housing. The battery cell can include an electrolyte disposed in the inner region defined by the housing. The battery cell can include a first polarity tab that electrically couples the electrolyte with the first polarity portion of the lid. The first polarity tab including a spring element that applies a force at a predetermined level to the electrolyte.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting a cross-sectional view of an example battery cell for a battery pack in an electric vehicle;

FIG. 2 is a top view of a lid of a battery cell for a battery pack in an electric vehicle;

FIG. 3A is a block diagram depicting a cross-sectional view of an example battery cell for a battery pack in an electric vehicle;

FIG. 3B is a block diagram depicting a spring element in a first state;

FIG. 3C is a block diagram depicting a spring element in a second state;

FIG. 3D is a block diagram depicting a spring element having a continuous curve shape;

FIG. 4 is a block diagram depicting a cross-sectional view of an example battery pack for holding battery cells in an electric vehicle;

FIG. 5 is a block diagram depicting a cross-sectional view of an example electric vehicle installed with a battery pack;

FIG. 6 is a flow diagram depicting an example method of providing battery cells for battery packs for electric vehicles; and

FIG. 7 is a flow diagram depicting an example method of providing battery cells for battery packs for electric vehicles.

### DETAILED DESCRIPTION

Following below are more detailed descriptions of various concepts related to, and implementations of battery cells for battery packs in electric vehicles. The various concepts introduced above and discussed in greater detail below can be implemented in any of numerous ways.

The architecture of the battery cell described can simplify bonding of wires to a lid of the respective battery cell, for example, bonding of wires to a positive lid portion or a negative lid portion corresponding to positive and negative terminals, respectively, of the battery cell. The lid can be soldered or welded to a first end of the battery cell to provide an increased surface area that can be utilized for bonding. For example, the negative portion of the lid can be soldered or welded with the first end of a housing of the battery cell. The negative lid portion can be glass welded, spot welded, or ultrasonically welded to the first end (or rim) of the housing of the battery cell. By foregoing crimping to form a negative lid portion having only a small area (e.g., 1 mm to 2 mm in width) for wire bonding, the negative lid portions of the battery cells described here can be formed, for example, having a ring shape with a width of 2 mm to 8 mm, resulting in an increased wire bonding area. This facilitates coupling of the battery cell with other battery cells of a battery pack or with a drive train of an electric vehicle. The architecture of the battery cell described can include one or more tabs coupling an electrolyte disposed within the respective battery cell to at least one portion of a lid of the respective battery cell. The tab (e.g., positive tab, negative tab) can be or include a spring element to mitigate, dampen, avoid, or otherwise lessen the vibration of the electrolyte. For example, in the absence of a crimped lid, the electrolyte may be susceptible to vibration, e.g., during operation of an electric vehicle that includes the respective battery cell. The tab having a spring element can bias or apply force to the electrolyte to prevent or dampen vibration of the electrolyte.

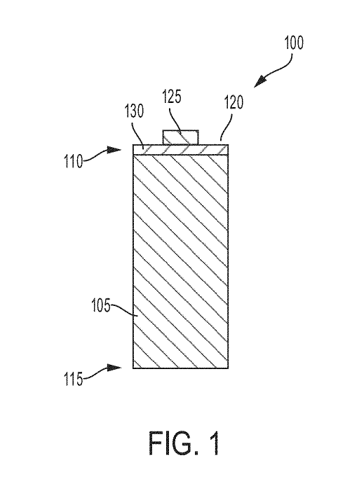

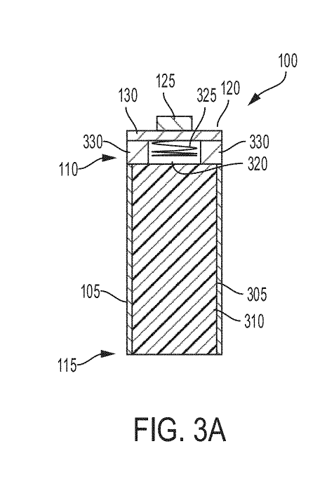

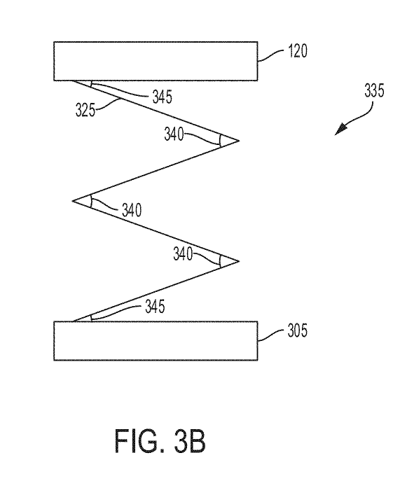

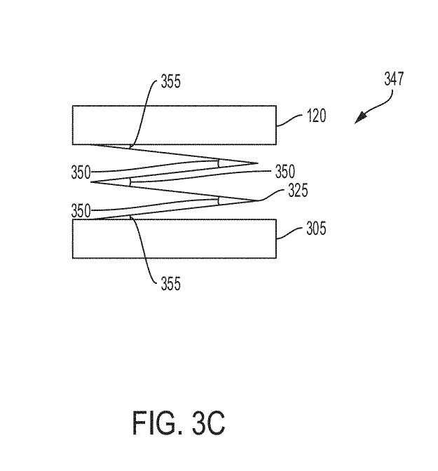

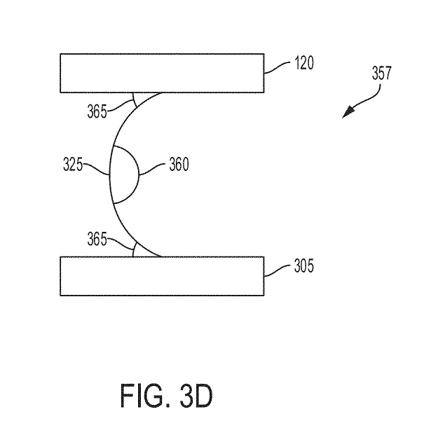

FIG. 1, among others, depicts a cross-sectional view of a battery cell 100 for a battery pack in an electric vehicle. The battery cell 100 can provide energy or store energy for an electric vehicle. For example, the battery cell 100 can be included in a battery pack used to power an electric vehicle. The battery cell 100 can include a housing 105 having a first end 110 (e.g., top end) and a second end 115 (e.g., bottom end) and defining an inner region (e.g., inner region 310 of FIG. 3A). The battery cell 100 can be a lithium-air battery cell, a lithium ion battery cell, a nickel-zinc battery cell, a zinc-bromine battery cell, a zinc-cerium battery cell, a sodium-sulfur battery cell, a molten salt battery cell, a nickel-cadmium battery cell, or a nickel-metal hydride battery cell, among others. The battery cell 100 can include at least one housing 105. The housing 105 can be included or contained in a battery pack (e.g., a battery array or battery module) installed a chassis of an electric vehicle. The housing 105 can have the shape of a cylindrical casing or cylindrical cell with a circular, ovular, or elliptical base, as depicted in the example of the battery cell of FIG. 1. A height of the housing 105 can be greater than a width of the housing 105. For example, the housing 105 can have a length (or height) in a range from 65 mm to 75 mm and a width (or diameter for circular examples) in a range from 17 mm to 25 mm. In some examples the width or diameter of the housing 105 can be greater than the length (e.g., height) of the housing 105. The housing 105 can be formed from a prismatic casing with a polygonal base, such as a triangle, square, a rectangular, a pentagon, or a hexagon, for example. A height of such a prismatic cell housing 105 can be less than a length or a width of the base of the housing 105. The battery cell can be a cylindrical cell 21 mm in diameter and 70 mm in height. Other shapes and sizes are possible, such as a rectangular cells or rectangular cells with rounded edges, of cells between 17 mm to 25 mm in diameter or width, and 65 mm to 75 mm in length or height.

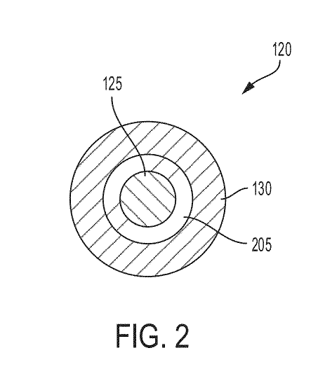

The battery cells 100 described herein can include both the positive terminal (e.g., positive lid portion 125) and the negative terminal (e.g., negative lid portion 130) disposed at a same lateral end (e.g., the top end) of the battery cell 100. The battery cells 100 can be coupled to positive and negative current collectors of the battery module or battery pack through positive and negative portions of the respective battery cell. For example, the battery cell 100 can include at least one lid 120. The lid 120 can include a positive lid portion 125, a negative lid portion 130 and a first isolation layer (e.g., isolation layer 205 of FIG. 2) disposed between the positive lid portion 125 and the negative lid portion 130. The negative lid portion 130 can couple with the first end 110 of the housing 105. The lid 120 can include a current interrupter device (e.g., CID), an electrical fuse, a thermal fuse, a rupture disk, or a printed circuit board (PCB) protection board, among others. For example, the CID, in response to an occurrence of a failure condition (e.g., excess voltage over 4.0 volts or pressure above 1,000 kPa), the CID of the lid 120 can initially electrically decouple the battery cell 100 from one or bus bars the respective battery cell 100 is coupled with.

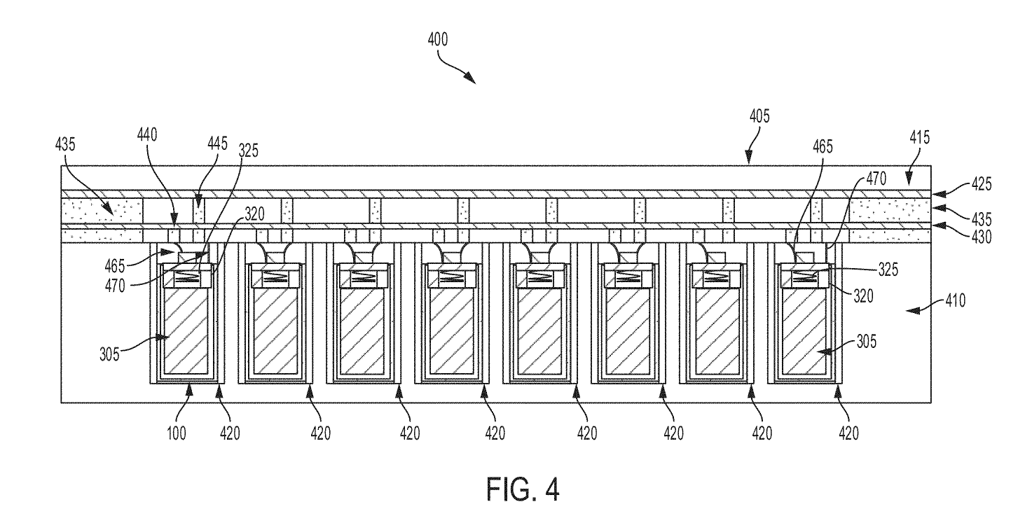

The positive lid portion 125 can operate as the positive terminal of the battery and the negative lid portion 130 can operate as the negative terminal of the battery cell 100. Via a module tab connection (or other technique such as wire bonding) the positive lid portion 125 and the negative lid portion 130 can couple the battery cells 100 with current collectors of the battery module from lateral ends (e.g., top or bottom) or from the longitudinal sides of the respective battery cells 100. For example, the battery cell 100 can couple with positive and negative current collectors of a battery module of an electric vehicle through the positive lid portion 125 and the negative lid portion 130 of the lid 120 (as shown in FIG. 4). One or more battery modules can form a battery pack disposed in an electric vehicle to power a drive train of the electric vehicle.

The battery cells 100 can be formed using a cap and case (or lid and can) design such that a larger area is provided to couple the electrical wires to the battery terminals (e.g., to the positive lid 125 or to the negative lid 130) and an increased interior area (or volume) within the housing or can 105 of the battery cells 100 is provided to support a larger electrolyte, (e.g., electrolyte 305 of FIG. 3A). The larger electrolyte (e.g., greater than 65 mm in length) can result in a higher powered battery cell 100 relative to a battery cell having a crimped design with a gasket to hold at least one terminal in place at a lateral end of the battery cell.

FIG. 2, among others, depicts a top view 200 of the lid 120. The lid 120 can include the positive lid portion 125, the negative lid portion 130 and an isolation layer 205 formed or disposed between the positive lid portion 125 and the negative lid portion 130. The isolation layer 205 can include a nonconductive layer or non-conductive material, and can electrically isolate the positive lid portion 125 from the negative lid portion 130. For example, the isolation layer 205 can be positioned to prevent or avoid a short circuit between the positive lid portion 125 and the negative lid portion 130.

The lid 120 can include at least one electrically or thermally conductive material, or combinations thereof. The electrically conductive material can also be a thermally conductive material. The electrically conductive material for the lid 120 (including the positive lid portion 125 and negative lid portion 130) can include a metallic material, such as aluminum, an aluminum alloy with copper, silicon, tin, magnesium, manganese or zinc (e.g., of the aluminum 5000 or 6000 series), iron, an iron-carbon alloy (e.g., steel), silver, nickel, copper, and a copper alloy, among others. The lid 120 can be formed having a diameter in a range from 17 mm to 27 mm. For example, the diameter of the lid 120 can be 21 mm. The positive lid portion 125 can have a diameter in a range from 2 mm to 8 mm. The positive lid portion 125 can have a thickness in a range from 0.5 mm to 2 mm (e.g., less than 2 mm). The negative lid portion 130 can have a diameter or width in a range from 2 mm to 8 mm. For example, the distance from a border between the isolation layer 205 and the negative lid portion 130 to an outer edge (e.g., opposite edge from border between the isolation layer 205 and the negative lid portion 130) of the negative lid portion 130 can be in a range from 2 mm to 8 mm. The negative lid portion 130 can have a thickness in a range from 0.5 mm to 2 mm (e.g., less than 2 mm).

A distance between or distance separating the positive lid portion 125 and the negative lid portion 130 can correspond to a thickness of the isolation layer 205. The isolation layer 205 can have a thickness in a range from 2 mm to 8 mm. For example, a distance from a first border between the isolation layer 205 and the positive lid portion 125 to a second border between the isolation layer 205 and the negative lid portion 130 can be in a range from 2 mm to 8 mm. The spatial separation between the positive lid portion 125 and the negative lid portion 130 can allow for suitable or sufficient bonding spacing and the avoidance of electrical arcing between positive wirebonds or connections to the positive lid portion 125 and negative wirebonds or connections to the negative lid portion 130.

The isolation layer 205 can include a ring insulator. For example, a ring isolation layer 205 can be disposed between the positive lid portion 125 and the negative lid portion 130 to electrically isolate the positive lid portion 125 and the negative lid portion 130. The isolation layer 205 can hold or bind the positive lid portion 125 and the negative lid portion 130 together. For example, the isolation layer 205 can include or use adhesive(s) or other binding material(s) or mechanism(s) to hold or bind the positive lid portion 125 and the negative lid portion 130 together.

The isolation layer 205 can include insulation material, plastic material, epoxy material, FR-4 material, or polypropylene materials. The dimensions or geometry of the isolation layer 205 can be selected to provide a predetermined creepage clearance or spacing (sometimes referred to as creepage-clearance specification or requirement) between the positive lid portion 125 and the negative lid portion 130. For example, a thickness or width of the isolation layer 205 can be selected such that the positive lid portion 125 is spaced at least 3 mm from the negative lid portion 130 when the isolation layer 205 is disposed between the positive lid portion 125 and the negative lid portion 130. The isolation layer 205 can be formed having a shape or geometry that provides the predetermined creepage, clearance or spacing.

The thickness and insulating structure of the isolation layer 205, that separate the positive lid portion 125 and the negative lid portion 130, can provide the predetermined creepage, clearance or spacing. Thus, the dimensions of the isolation layer 205 can be selected, based in part, to meet creepage-clearance specifications or requirements. The dimensions of the isolation layer 205 can be configured to reduce or eliminate arcing between the positive lid portion 125 and the negative lid portion 130. The isolation layer 205 can enable or support the lamination, and can include an isolation material or insulation material having high dielectric strength that can provide electrical isolation between the positive lid portion 125 and the negative lid portion 130. The lamination layer can provide a conformal coating that is disposed over one or more portions of the positive lid portion 125, the isolation layer 205, or the negative lid portion 130, and can protect against shorting from the positive lid portion 125 and the negative lid portion 130.

The lid 120 can be formed having a variety of different shapes. The shape of the lid 120 can correspond to or be the same as the shape of the housing 105 of the battery cell 100. For example, the lid 120 can be formed having a circular shape (as shown in FIG. 2). The lid 120 can be formed having, but not limited to, a square shape, rectangular shape, or octagonal shape.

FIG. 3A, among others, depicts a cross-sectional view 300 of the battery cell 100 having an electrolyte 305 disposed within an inner region 310 of the housing 105. At least one isolation layer 330 is disposed between the electrolyte and the lid 120. At least one tab 320 can couple portions of the electrolyte 305 to portions of the lid 120. The housing 105 of the battery cell 100 can include at least one electrically or thermally conductive material, or combinations thereof. The electrically conductive material can also be a thermally conductive material. The electrically conductive material for the housing 105 of the battery cell 100 can include a metallic material, such as aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The electrically conductive material and thermally conductive material for the housing 105 of the battery cell 100 can include a conductive polymer. To evacuate heat from inside the battery cell 100, the housing 105 can be thermally coupled to a thermoelectric heat pump (e.g., a cooling plate) via an electrically isolation layer. The housing 105 can include an electrically insulating material. The electrically insulating material can be a thermally conductive material. The electrically insulating and thermally conductive material for the housing 105 of the battery cell 100 can include a ceramic material (e.g., silicon nitride, silicon carbide, titanium carbide, zirconium dioxide, beryllium oxide, and among others) and a thermoplastic material (e.g., polyethylene, polypropylene, polystyrene, or polyvinyl chloride), among others. To evacuate heat from inside the battery cell 100, the housing 105 can be thermally coupled to a thermoelectric heat pump (e.g., a cooling plate). The housing 105 can be directly thermally coupled to the thermoelectric heat pump without an addition of an intermediary electrically insulating layer.

The housing 105 of the battery cell 100 can include the first end 110 (e.g., top portion) and the second end 115 (e.g., bottom portion). The housing 105 can define an inner region 310 between the first end 110 and the second end 115. For example, the inner region 310 can include an interior of the housing 105. The first end 110, inner region 310, and the second end 115 can be defined along one axis of the housing 105. For example, the inner region 310 can have a width (or diameter for circular examples) of 2 mm to 6 mm and a length (or height) of 50 mm to 70 mm. The first end 110, inner region 310, and second end 115 can be defined along a vertical (or longitudinal) axis of cylindrical casing forming the housing 105. The first end 110 can be at one end of the housing 105 (e.g., a top portion as depicted in FIG. 1). The second end 115 can be at an opposite end of the housing 105 (e.g., a bottom portion as depicted in FIG. 1). The end of the second end 115 can encapsulate or cover the corresponding end of the housing 105.

At least one electrolyte 305 can be disposed in the inner region 310 of the housing 105. The electrolytes 305 can include a first polarity and a second polarity charge region or terminus, such as a negative electronic charge region or terminus and a positive electronic charge region or terminus. A first polarity portion (e.g., positive polarity) of the electrolyte 305 can be coupled to the first polarity (e.g., positive) lid portion 125 of the lid 120 to form a first polarity (e.g., positive) surface area on the lid 120 for first polarity (e.g., positive) wire bonding. At least one second polarity (e.g., negative) tab can couple the electrolytes 305 (e.g., negative region of electrolytes 305) with the surface of the housing 105 or the second polarity (e.g., negative) lid portion 130 of the lid 120. For example, a negative portion of the electrolytes 305 can be coupled with one or more surfaces of the housing 105 or the negative lid portion 130 of the lid 120, such as to form a negative surface area on the lid 120 for negative wire bonding. Thus, the lid 120 can include a negative surface area and a positive surface area. The first polarity portion or the second polarity portion of the electrolyte 305 can be coupled with the housing 105 or the lid 120 through at least one first polarity tab or second polarity tab, respectively. An isolation layer 330 may be disposed between an inner surface of the housing 105 and the electrolytes 305 disposed within the inner region of the housing 105 to electrically insulate the housing 105 from the electrolytes 305.

The electrolyte 305 can include any electrically conductive solution, dissociating into ions (e.g., cations and anions). For a lithium-ion battery cell, for example, the electrolyte 305 can include a liquid electrolyte, such as lithium bisoxalatoborate (LiBC4O8 or LiBOB salt), lithium perchlorate (LiClO4), lithium hexaflourophosphate (LiPF6), and lithium trifluoromethanesulfonate (LiCF3SO3). The electrolyte 305 can include a polymer electrolyte, such as polyethylene oxide (PEO), polyacrylonitrile (PAN), poly(methyl methacrylate) (PMMA) (also referred to as acrylic glass), or polyvinylidene fluoride (PVdF). The electrolyte 305 can include a solid-state electrolyte, such as lithium sulfide (Li2S), magnesium, sodium, and ceramic materials (e.g., beta-alumna).

A single electrolyte 305 can be disposed within inner region 310 of the housing 105 or multiple electrolytes 305 (e.g., two electrolytes, more than two electrolytes) can be disposed within inner region 310 of the housing 105. For example, two electrolytes 305 can be disposed within inner region 310 of the housing 105. The number of electrolytes 305 can vary and can be selected based at least in part on a particular application of the battery cell 100.

At least one isolation layer 330 can electrically insulate portions of the lid 120 (e.g., positive lid portion 125, negative lid portion 130) from the electrolyte 305. The isolation layer 330 can be disposed between the lid 120 and the electrolyte 305. For example, a first isolation layer 330 can be disposed between the negative lid portion 130 and a surface (e.g., top surface) of the electrolyte 305 and a second isolation layer 330 can be disposed between the negative lid portion 130 and a surface (e.g., top surface) of the electrolyte 305. The first and second isolation layer 330 can be spaced a distance from each other with the distance corresponding to a width or thickness of the tab 320.

The isolation layer 330 can include nonconductive layer or non-conductive material, and can electrically isolate the electrolyte 305 from the lid 120, the positive lid portion 125, or the negative lid portion 130. For example, isolation layer 330 can be disposed between the housing 105 and the negative lid portion 130. The isolation layer 330 can include insulation material, plastic material, epoxy material, FR-4 material, or polypropylene materials. The dimensions or geometry of the isolation layer 330 can be selected to provide a predetermined creepage clearance or spacing (sometimes referred to as creepage-clearance specification or requirement) between the electrolyte 305 and the lid 120 (e.g., positive lid portion 125, negative lid portion 130). For example, a thickness or width of the isolation layer 330 can be selected such that the electrolyte 305 is spaced at least 3 mm from the negative lid portion 130 when the isolation layer 330 is disposed between the electrolyte 305 and the negative lid portion 130. The isolation layer 330 can be formed having a ring like shape and have dimensions such that a distance between an inner surface (e.g., inner diameter) and an outer surface (e.g., outer diameter) can be in a range from 1 mm to 3 mm (e.g., 2 mm). The isolation layer 330 can be formed having a shape or geometry that provides the predetermined creepage, clearance or spacing.

At least one tab 320 can couple portions of the lid 120 to a surface of the electrolyte 305. For example, the lid 120 can couple with the electrolyte 305 through one or more tabs 320. The battery cell 100 can include at least one first polarity (e.g., positive) tab 320 or at least one negative tab 320. For example, a negative tab 320 can couple the electrolyte 305 with the negative lid portion 130 of the lid 120. When the negative lid portion 130 of the lid 120 is coupled with the electrolyte 305 through the negative tab 320, the housing 105 may include non-conductive material. A positive tab 320 can couple the electrolyte 305 (e.g., positive region of electrolytes 305) with the positive lid portion 125 of the lid 120. The negative tab 320 can be welded or otherwise coupled to the negative lid portion 130 of lid 120 and to the negative portion of the electrolyte 305. The positive tab 320 can be welded or otherwise coupled to the positive lid portion 125 of the lid 120 and to the first polarity (e.g., positive) portion of the electrolyte 305. In lieu of a negative tab 320, the housing 105 can electrically couple the electrolyte 305 with the negative lid portion 130 of the lid 120. The negative lid portion 130 may include one or more holes, openings, or apertures to allow a connection from the positive lid portion 125 to the electrolyte 305 through the positive tab 320. For example, the positive tab 320 can extend through the one or more holes, openings, or apertures of the negative lid portion 130 to couple the positive lid portion 125 with the electrolyte 305.

The (positive or negative polarity) tab 320 can include a spring element 325 to provide or apply a force at a predetermined level to the electrolyte. The (positive or negative polarity) tab 320 can include a spring element 325 to provide or apply a force at a predetermined level to an electrode or jelly-roll disposed within the inner region 310. For example, and as depicted in FIG. 3A, the first polarity (e.g., positive) tab 320 can be or include a spring element 325 having for example a folding tab shape. The spring configuration of the positive tab 320 can mitigate, avoid, or lessen the vibration of the electrolyte 305. For example, a crimped design can include a shoulder region of the housing 105 that can at least in part fix the electrolyte 305 in position. In the absence of the crimping operation, the electrolyte 305 may be susceptible to vibration, e.g., during operation of an electric vehicle that includes the battery cell 100. The positive tab 320 having a spring element 325 can bias or apply force to the electrolyte 305 to prevent or dampen vibration of the electrolyte 305, such as but not limited to, during operation of an electric vehicle that includes the battery cell 100. The positive tab 320 having a spring element 325 can bias or apply force to an electrode or jelly-roll of 0 N to prevent or limit deformation. The spring element 325 can provide force during vibration of the respective battery cell 100 during operation of an electric vehicle that includes the battery cell 100 corresponding to the vibration.

Tab 320 can include aluminum, plastic materials or steel materials (e.g., alloy steel, carbon steel). The spring element 325 can be formed within or embedded within the tab 320. The spring element 325 can include aluminum, plastic materials or steel materials (e.g., alloy steel, carbon steel). The tab 320 can be a spring element 325. For example, the entire tab 320 can be or correspond to the spring element 325. Thus, the spring element 325 can electrically couple a portion of the lid 120 with a portion of the electrolyte 305. For example, the spring element 325 can contact at least one surface of the lid 120 (e.g., first polarity lid portion 125, positive lid portion 125, second polarity lid portion 130, negative lid portion 130) and the spring element 325 can contact at least one surface or portion of the electrolyte 305 (e.g., first polarity portion of electrolyte 305, positive portion of electrolyte 305, second polarity portion of electrolyte 305, negative portion of electrolyte 305). The tab 320 can be formed from the same material as the spring element 325. The tab 320 can be formed from a first material and the spring element 325 can be formed from a second different material. The material of the tab 320 can be different from the material forming the spring element 325. For example, the spring element 325 can be a separate component from the tab 320. The spring element 325 of a second material can be embedded within or coupled with a portion of the tab 320 of a first material. The tab 320 or spring element 325 can include any device or materials that can store energy or receive energy from one or more elements in contact with respective device or provide energy to one or more elements in contact with respective device. The tab 320 can be formed from or include aluminum material. The spring element 325 can include a coil or spring. The dimensions of the tab 320 or spring 325 can correspond to the dimensions (e.g., height) of the electrolyte 305 and the dimensions (e.g., height) of the housing 105. For example, the tab 320 or spring 325 can be sized to accommodate the electrolyte 305 disposed within the housing 105 and under the lid 320. The tab 320 or spring 325 can have a length or height in a range from 1 mm to 4 mm. For example, the tab 320 or spring 325 can be formed having dimensions such as but not limited to, a thickness of 1 mm, a length of 70 mm, and a width of 4 mm (1 mm (t)×70 mm (L)×4 mm (w)).

FIG. 3B, among others, depicts the spring element 325 in a first state 347. The first state 347 can correspond to an uncompressed state or a resting state. For example, the spring element 325 can be disposed between at least one surface of the lid 120 and at least one surface of the electrolyte 305. The lid 120 can correspond to at least one surface of the positive lid portion 125 or at least one surface of the negative lid portion 130. The first state 335 may correspond to an uncontracted state. The spring element 325 in the first state 335 can apply force at a first level or predetermined level to the surface of the lid 120 and the surface of the electrolyte 305. The spring element 325 in the first state 3335 can apply force at the same level (e.g., equivalent force) to both the surface of the lid 120 and the surface of the electrolyte 305. The spring element 325 in the first state 335 can apply force at a different level (e.g., greater than, less than) to the surface of the lid 120 as compared to the force applied to the surface of the electrolyte 305. The first level of force of the first state 335 can be different (e.g., less than, more than) than a second level of force applied by the spring element 325 in a second state (e.g., second state 347 of FIG. 3C). For example, the spring element 325 in the first state 335 can be an uncompressed state can have less potential energy than the spring element 325 in a compressed state. Thus, the spring element 325 may apply less force to surface of the lid 120 and the surface of the electrolyte 305.

In the first state 335, the spring element 325 can have one or more bends or one or more inflection points. For example, in the first state 335, the spring element 325 can have a zig zap shape, an “S” shape, a “Z” shape, or curved shape. As depicted in FIG. 3B, the spring element 325 in the first state 335 can have three inflection points forming a first angle 340, a second angle 340, and a third angle 340. The first angle 340 can be the same as the second angle 340 and the third angle 340. The first angle 340 can be the same as the second angle 340 and different (e.g., greater than, less than) than the third angle 340. The first angle 340 can different (e.g., greater than, less than) than the second angle 340 and the same as the third angle 340. The first angle 340 can different (e.g., greater than, less than) than the second angle 340 and different (e.g., greater than, less than) than the third angle 340. The second angle 340 can be different (e.g., less than, greater than) the third angle 340. The first angle 340, second angle 340, and third angle 340 of the spring element 325 in the first state 335 can range from 10 degrees to 90 degrees. The first angle 340, second angle 340, and third angle 340 of the spring element 325 in the first state 335 can vary within or outside this range. The spring element 325 in the first state 335 can form a first surface angle 345 with respect to the surface of the lid 120 and a second surface angle 345 with respect to the surface of the electrolyte 305. The first surface angle 345 can be the same the second surface angle 345. The first surface angle 345 can different (e.g., greater than less than) than the second surface angle 345. The first surface angle 345 and the second surface angle 345 of the spring element 325 in the first state 335 can range from 10 degrees to 90 degrees. The first surface angle 345 and the second surface angle 345 of the spring element 325 in the first state 335 can vary within or outside this range. The first surface angle 345 or the second surface 345 can be the same as one or more of the first angle 340, the second angle 340 or the third angle 340. The first surface angle 345 or the second surface 345 can be the same as each of the first angle 340, the second angle 340 or the third angle 340. The number of bends or inflections points of the spring element 325 in the first state 335 can be less than or more than the number of bends or inflection points illustrated in FIG. 3B. The spring element 325 can form sharp surface angles 345, as in FIGS. 3A-3C, or can form rounded softer angles about inflection points.

FIG. 3C, among others, depicts the spring element 325 in a second state 347. The second state 347 can correspond to a compressed state or an active state. For example, the spring element 325 can be disposed between at least one surface of the lid 120 and at least one surface of the electrolyte 305. The lid 120 can correspond to at least one surface of the positive lid portion 125 or at least one surface of the negative lid portion 130. The spring element 325 in the first state 347 can apply force at a second level or predetermined level to the surface of the lid 120 and the surface of the electrolyte 305. The spring element 325 in the second state 347 can apply force at the same level to both the surface of the lid 120 and the surface of the electrolyte 305. The spring element 325 in the second state 347 can apply force at a different level (e.g., greater than, less than) to the surface of the lid 120 as compared to the force applied to the surface of the electrolyte 305. The second level of force of the second state 347 can be different (e.g., less than, more than) than a first level of force applied by the spring element 325 in a first state 335 (e.g., first state 335 of FIG. 3B). For example, the spring element 325 in the second state 347 can be a compressed state that can have more potential energy than the spring element 325 in an uncompressed state. The potential energy can be provided or generated by force applied by the surface of the lid 120 on the spring element 325. The potential energy can be provided or generated by force applied by the surface of electrolyte 305 on the spring element 325. The potential energy can be provided or generated by force applied by a combination of the surface of the lid 120 and the surface of electrolyte 305 on the spring element 325. Thus, the spring element 325 can apply more force (e.g., reactive force) or absorb more force as the spring element 325 contracts (e.g., shrinks in vertical length, shrinks in horizontal length) to transition from the first state 335 to the second state 347. The spring element 325 in the second state 347 in the second state may apply more force to surface of the lid 120 and the surface of the electrolyte 305.

In the second state 347, the spring element 325 can have one or more bends or one or more inflection points. For example, in the second state 347, the spring element 325 can have a zig zap shape, an “S” shape, a “Z” shape, or curved shape. As depicted in FIG. 3C, in the second state 347, the spring element 325 can have three inflection points forming a first angle 350, a second angle 350, and a third angle 350. The first angle 350 can be the same as the second angle 350 and the third angle 350. The first angle 350 can be the same as the second angle 350 and different (e.g., greater than, less than) than the third angle 350. The first angle 350 can different (e.g., greater than, less than) than the second angle 350 and the same as the third angle 350. The first angle 350 can different (e.g., greater than, less than) than the second angle 350 and different (e.g., greater than, less than) than the third angle 350. The second angle 350 can be different (e.g., less than, greater than) the third angle 350. The first angle 350, second angle 350, and third angle 350 of the spring element 325 in the second state 347 can range from 0 degrees to 80 degrees. The first angle 350, second angle 350, and third angle 350 of the spring element 325 in the second state 347 can vary within or outside this range. The spring element 325 in the second state 347 can form a first surface angle 355 with respect to the surface of the lid 120 and a second surface angle 355 with respect to the surface of the electrolyte 305. The first surface angle 355 can be the same the second surface angle 355. The first surface angle 355 can different (e.g., greater than less than) than the second surface angle 355. The first surface angle 355 and the second surface angle 355 of the spring element 325 in the second state 347 can range from 0 degrees to 80 degrees. The first surface angle 355 and the second surface angle 355 of the spring element 325 in the second state 347 can vary within or outside this range. The first surface angle 355 or the second surface 355 can be the same as one or more of the first angle 350, the second angle 350 or the third angle 350. The first surface angle 355 or the second surface 355 can be the same as each of the first angle 350, the second angle 350 or the third angle 350. The number of bends or inflections points of the spring element 325 in the second state 347 can be less than or more than the number of bends or inflection points illustrated in FIG. 3C. As depicted in FIGS. 3B and 3C, the angles 350 corresponding to the plurality of inflection points formed by the spring element 325 in the second state 347 can be different from the angles 340 corresponding to the plurality of inflection points formed by the spring element 325 in the first state 335. For example, the angles 350 corresponding to the plurality of inflection points formed by the spring element 325 in the second state 347 can be less than the angles 340 corresponding to the plurality of inflection points formed by the spring element 325 in the first state 335. The angles 350 corresponding to the plurality of inflection points formed by the spring element 325 in the second state 347 can be greater than the angles 340 corresponding to the plurality of inflection points formed by the spring element 325 in the first state 335. The angles 350 corresponding to the plurality of inflection points formed by the spring element 325 in the second state 347 can have a range of values that are different than a range of values of the angles 340 corresponding to the plurality of inflection points formed by the spring element 325 in the first state 335.

The spring element 325 in a first state can include a plurality of first inflections points that each form or define respective angles 340. The angles can be the same as or different from one another, and can range between 0 and 180 degrees. The spring element 325 in a second state includes a plurality of second inflections points that each form or define respective angles 340. The angles can be the same as or different from one another, and can range between 0 and 180 degrees. The angles in the second state can be less than the angles in the first state, for example.

FIG. 3D, among others, depicts the spring element 325 forming a continuous curve 357. For example, the continuous curve shape 357 can have a single bend or single inflection point. The spring element 325 having the continuous curve shape 357 can be disposed between at least one surface of the lid 120 and at least one surface of the electrolyte 305. The lid 120 can correspond to at least one surface of the positive lid portion 125 or at least one surface of the negative lid portion 130. The spring element 325 having a continuous curve shape 357 can electrically couple the lid 120 with the electrolyte 305. For example, the spring element 325 having a continuous curve shape 357 can electrically couple a positive lid portion 125 of the lid 120 with a positive portion of the electrolyte 305. The spring element 325 having a continuous curve shape 357 can electrically couple a negative lid portion 130 of the lid 120 with a negative portion of the electrolyte 305. The spring element 325 having a continuous curve shape 357 can apply a force at a predetermined level to the surface of the lid 120 and the surface of the electrolyte 305. The spring element 325 having a continuous curve shape 357 can apply a force at the same level to both the surface of the lid 120 and the surface of the electrolyte 305. The spring element 325 having a continuous curve shape 357 can apply a force at different level (e.g., greater than, less than) to the surface of the lid 120 as compared to a force applied to the surface of the electrolyte 305.

The spring element 325 having a continuous curve shape 357 can have or form an angle 360. The angle 360 can range from 0 degrees (e.g., compressed state) to 170 degrees (e.g., uncompressed state). The angle 360 can vary within or outside this range. The spring element 325 having a continuous curve shape 357 can have or form a first surface angle 365 with respect to the surface of the lid 120 and a second surface angle 365 with respect to the surface of the electrolyte 305. The first surface angle 365 can be the same as the second surface angle 365. The first surface angle 365 can be different (e.g., greater than, less than) than the second surface angle 365. The first surface angle 365 and the second surface angle 365 can have a value that ranges from 0 degrees (e.g., compressed state) to 80 degrees (e.g., uncompressed state). The angle of the first surface angle 365 and the second surface angle 365 can vary within or outside this range.

FIG. 4 depicts a cross-section view 400 of a battery pack 405 to hold a plurality of battery cells 100 in an electric vehicle. For example, the battery cells 100 in the battery pack 405 can include one or more tabs 320 having a spring element 325 to provide or apply a force at a predetermined level to an electrolyte 305 disposed within the respective battery cell 100. The battery pack 405 can include a battery case 410 and a capping element 415. The battery case 410 can be separated from the capping element 415. The battery case 410 can include or define a plurality of holders 420. Each holder 420 can include a hollowing or a hollow portion defined by the battery case 410. Each holder 420 can house, contain, store, or hold a battery cell 100. The battery case 410 can include at least one electrically or thermally conductive material, or combinations thereof. The battery case 410 can include one or more thermoelectric heat pumps. Each thermoelectric heat pump can be thermally coupled directly or indirectly to a battery cell 100 housed in the holder 420. Each thermoelectric heat pump can regulate temperature or heat radiating from the battery cell 100 housed in the holder 420. The first bonding element 465 and the second bonding element 470 can extend from the battery cell 100 through the respective holder 420 of the battery case 410. The battery pack 405 can include one or more battery cells 100. The battery cells 100 can be arranged in one or more battery modules within the battery pack. For example one or more battery modules within the battery pack 405 can each include a plurality of battery cells 100 arranged together in a fixed modular unit within the battery pack 405, such as 16 (or other number) of battery cells 100 arranged in a 4×4 matrix.

Between the battery case 410 and the capping element 415, the battery pack 405 can include a first busbar 425, a second busbar 430, and an electrically isolation layer 435. The first busbar 425 and the second busbar 430 can each include an electrically conductive material to provide electrical power to other electrical components in the electric vehicle. The first busbar 425 (sometimes referred to as a first current collector) can be connected or otherwise electrically coupled to the first bonding element 465 extending from each battery cell 100 housed in the plurality of holders 420 via a bonding element 445. The bonding element 445 can be bonded, welded, connected, attached, or otherwise electrically coupled to the second bonding element 470 extending from the battery cell 100. The first bonding element 465 can define the first polarity terminal for the battery cell 100. The first busbar 425 can define the first polarity terminal for the battery pack 405. The second busbar 430 (sometimes referred to as a second current collector) can be connected or otherwise electrically coupled to the second bonding element 470 extending from each battery cell 100 housed in the plurality of holders 420 via a bonding element 440. The bonding element 440 can be bonded, welded, connected, attached, or otherwise electrically coupled to the second bonding element 470 extending from the battery cell 100. The second bonding element 470 can define the second polarity terminal for the battery cell 100. The second busbar 430 can define the second polarity terminal for the battery pack 405.

The first busbar 425 and the second busbar 430 can be separated from each other by the electrically isolation layer 435. The electrically isolation layer 435 can include spacing to pass or fit the first bonding element 465 connected to the first busbar 425 and the second bonding element 470 connected to the second busbar 430. The electrically isolation layer 435 can partially or fully span the volume defined by the battery case 410 and the capping element 415. A top plane of the electrically isolation layer 435 can be in contact or be flush with a bottom plane of the capping element 415. A bottom plane of the electrically isolation layer 435 can be in contact or be flush with a top plane of the battery case 410. The electrically isolation layer 435 can include any electrically insulating material or dielectric material, such as air, nitrogen, sulfur hexafluoride (SF₆), porcelain, glass, and plastic (e.g., polysiloxane), among others to separate the first busbar 425 from the second busbar 430.

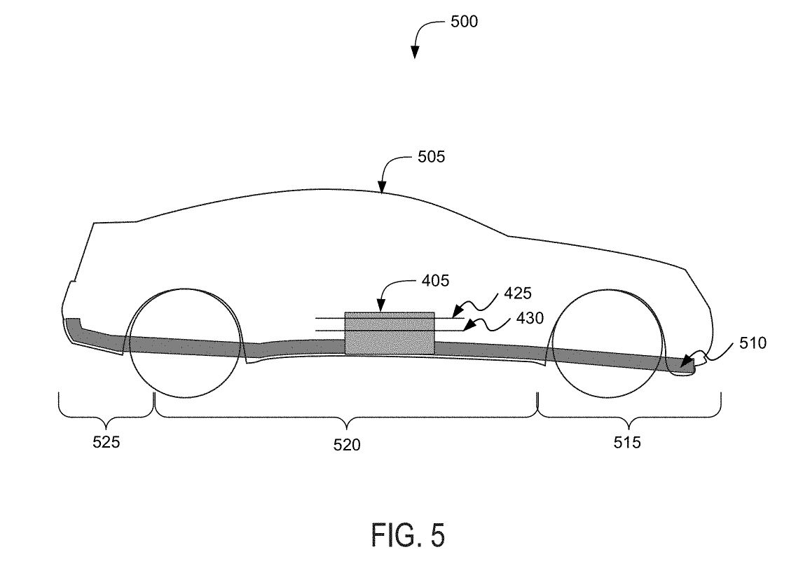

FIG. 5 depicts a cross-section view 500 of an electric vehicle 505 installed with a battery pack 405. The battery pack 405 can include at least one battery cell 100 having at least one tab 320. The tab 320 can include at least one spring element 325 to provide or apply a force at a predetermined level to an electrolyte 305 disposed within the respective battery cell 100. For example, the battery cells 100 described herein can be used to form battery packs 405 residing in an electric vehicle 505 for an automotive configuration. The electric vehicle 505 can include an autonomous, semi-autonomous, or non-autonomous human operated vehicle. The electric vehicle 505 can include a hybrid vehicle that operates from on-board electric sources and from gasoline or other power sources. The electric vehicle 505 can include automobiles, cars, trucks, passenger vehicles, industrial vehicles, motorcycles, and other transport vehicles. The electric vehicle 505 can include a chassis 510 (sometimes referred to herein as a frame, internal frame, or support structure). The chassis 510 can support various components of the electric vehicle 505. The chassis 510 can span a front portion 515 (sometimes referred to herein a hood or bonnet portion), a body portion 520, and a rear portion 525 (sometimes referred to herein as a trunk portion) of the electric vehicle 505. The front portion 515 can include the portion of the electric vehicle 505 from the front bumper to the front wheel well of the electric vehicle 505. The body portion 520 can include the portion of the electric vehicle 505 from the front wheel well to the back wheel well of the electric vehicle 505. The rear portion 525 can include the portion of the electric vehicle 505 from the back wheel well to the back bumper of the electric vehicle 505.

The battery pack 405 that includes at least one battery cell 100 having at least one tab 320 having at least one spring element 325 can be installed or placed within the electric vehicle 505. For example, the battery pack 405 can couple with a drive train unit of the electric vehicle 505. The drive train unit may include components of the electric vehicle 505 that generate or provide power to drive the wheels or move the electric vehicle 505. The drive train unit can be a component of an electric vehicle drive system. The electric vehicle drive system can transmit or provide power to different components of the electric vehicle 505. For example, the electric vehicle drive train system can transmit power from the battery pack 405 to an axle or wheels of the electric vehicle 505. The battery pack 405 can be installed on the chassis 510 of the electric vehicle 505 within the front portion 515, the body portion 520 (as depicted in FIG. 5), or the rear portion 525. A first bus-bar 425 and a second bus-bar 430 can be connected or otherwise be electrically coupled with other electrical components of the electric vehicle 505 to provide electrical power from the battery pack 405 to the other electrical components of the electric vehicle 505. For example, the first busbar 425 can couple with a positive lid portion 125 of a lid 120 of at least one battery cell 100 of the battery pack 405 through a wirebond or bonding element (e.g., bonding element 445 of FIG. 4). The second busbar 430 can couple with a negative lid portion 130 of a lid 120 of at least one battery cell 100 of the battery pack 405 through a wirebond or bonding element (e.g., bonding element 440 of FIG. 4).

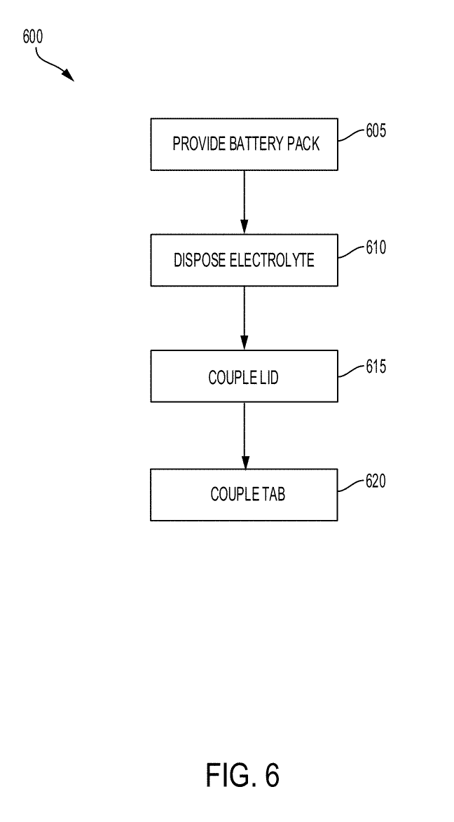

FIG. 6 depicts a method 600 of providing battery cell 100 of a battery pack 405 for electric vehicles 505. The method 600 can include providing a battery pack 405 (ACT 605). For example, the method 600 can include providing a battery pack 405 having a battery cell 100. The battery cell 100 can include a housing 105 that includes a first end 110 and a second end 115 and defining an inner region 310. The housing 105 can be formed having or defining an inner region 310. The battery cell 100 can be a lithium ion battery cell, a nickel-cadmium battery cell, or a nickel-metal hydride battery cell. The battery cell 100 can be part of a battery pack 405 installed within a chassis 510 of an electric vehicle 505. The housing 105 can be formed from a cylindrical casing with a circular, ovular, elliptical, rectangular, or square base or from a prismatic casing with a polygonal base.

The method 600 can include disposing an electrolyte 305 in the inner region 310 defined by the housing 105 (ACT 610). The electrolyte 305 can be disposed in the inner region 165 defined by the housing 105 of the battery cell 100. A single electrolyte 305 can be disposed within the inner region 310 or multiple electrolytes 305 (e.g., two or more) can be disposed within the inner region 310. The electrolytes 305 can be positioned within the inner region 310 such that they are spaced evenly from each other. For example, the electrolytes 305 can be positioned within the inner region 310 such that they are not in contact with each other. One or more isolation layers may be disposed between different electrolytes 305 within the same or common inner region 310. The electrolytes 305 can be positioned within the inner region 310 such that they are spaced a predetermined distance from an inner surface of the housing 105. For example, one or more isolation layers may be disposed between different inner surfaces of the housing 105 and the electrolytes 305 within the inner region 310 to insulate the housing 105 from the electrolytes 305. Thus, a distance the electrolytes 305 are spaced from the inner surface of the housing 105 can correspond to a thickness of the isolation layers.

One or more isolation layers 330 can be disposed between the electrolyte 305 and inner surfaces of the housing 105. For example, the isolation layers 330 can electrically insulate portions or surfaces of the housing 105 from the electrolyte 305. The isolation layers 330 can electrically insulate portions or surfaces of a lid 120 from the electrolyte 305. For example, one or more isolation layers 330 can be disposed over a top surface of the electrolyte 305. The isolation layers 330 can be disposed between the electrolytes 305 and portions of a lid 120. For example, a first isolation 330 or a second isolation layer 330 can be disposed between the electrolyte 305 and the negative lid portion 130 of the lid 120. The first isolation layer 330 can be disposed between a top surface of the electrolyte 305 and a negative lid portion 130. The second isolation layer 330 can be disposed between the top surface of the electrolyte 305 and the negative lid portion 130. The isolation layer 330 can be formed having a ring shape. For example, isolation layer 330 can be formed having a ring shape within an inner hole or inner aperture and a tab 320 can be disposed within the inner hole or the inner aperture of the ring shaped isolation layer 330.

The method 600 can include coupling a lid 120 to the first end 110 of the housing 105 (ACT 615). For example, the method 600 can include coupling a lid 120 to the first end 110 of the housing 105. The lid 120 can be formed having a first polarity (e.g., positive) portion 125, a second polarity (e.g., negative) portion 130 and a first isolation layer 205 disposed between the first polarity portion 125 and the second polarity portion 130. For example, a positive lid portion 125 can be formed on the lid 120. The positive lid portion 125 can be formed having a shape corresponding to the shape of the housing 105. The positive lid portion 125 can be formed having a circular, ovular, elliptical, rectangular, or square shape. The positive lid portion 125 can be formed having a diameter in a range from 2 mm to 8 mm. The first isolation layer 205 can be formed such that it is disposed between the positive lid portion 125 and the negative lid portion 130. For example, first isolation layer 205 can be formed or disposed such that it is in contact with at least one surface of the positive lid portion 125. The first isolation layer 205 can be formed or disposed around an outer perimeter or edge surface of the positive lid portion 125. The first isolation layer 205 can be formed or disposed under a bottom surface of the positive lid portion 125. The first isolation layer 205 can have a diameter in a range from 2 mm to 8 mm. The first isolation layer 205 can have a thickness in a range from 0.5 mm to 2 mm (e.g., less than 2 mm). The negative lid portion 130 can be formed or disposed such that it is in contact with at least one surface of the first isolation layer 205. The negative lid portion 130 can be formed or disposed around an outer perimeter or edge surface of the first isolation layer 205. The negative lid portion 130 formed or disposed under a bottom surface of the first isolation layer 205. The negative lid portion 130 can have a diameter (e.g., separation from an inner surface to an outer surface) in a range from 2 mm to 8 mm. The positive lid portion 125 can be electrically isolated from the negative lid portion 130 using the first isolation layer 205. For example, the first isolation layer 205 can be disposed or coupled between the positive lid portion 125 and the negative lid portion 130 to electrically insulate the positive lid portion 125 from the negative lid portion 130.

The second polarity (e.g. negative) portion 130 of the lid 120 can be welded or soldered with the first end 110 of the housing 105. The lid 120 can couple with the first end 110 of the housing 105. For example, the lid 120 can couple with the housing 105 by soldering or welding the lid 120 onto a surface, such as but not limited to the first end 110, of the housing 105. The second polarity portion 130 can be soldered or welded with the first end 110 of the housing 105. For example, the second polarity lid portion 130 can be glass welded, spot welded, or ultrasonically welded to the first end 110 (or rim) of the housing 105. Other methods and techniques can be user to couple the lid 120 to the housing 105. By foregoing crimping to form a negative lid portion having only a small area (e.g., 1 mm to 2 mm in width) for wire bonding, the negative lid portions 130 can be formed, for example, having a ring shape with a width of 2 mm to 8 mm, resulting in an increased wire bonding area. This facilitates coupling of the battery cell 100 with other battery cells of a battery pack 405 or with a drive train of an electric vehicle 505.

The lid 120 can be disposed over a surface of the electrolyte 305 disposed within the inner region 310 such that isolation layers 330 and a tab 320 are disposed between the lid 120 and the surface of the electrolyte 305. For example, the lid 120 can be disposed over a top surface of the electrolyte 305 with isolation layers 330 and a tab 320 disposed between the lid 120 and the surface of the electrolyte 305. Thus, the lid 120 can be positioned such that it is not in contact with the electrolyte 305. The lid 120 can be spaced a predetermined distance from the top surface of the electrolyte 305. For example, the lid 120 can be spaced a distance from the electrolyte 305 corresponding to the dimensions of the insulation layers 330 or the tab 320.

The method 600 can include electrically coupling, through a positive tab 320, the electrolyte 305 with the positive lid 125 (ACT 620). For example, the method 600 can include electrically coupling, through a first polarity tab 320, the electrolyte 305 with the first polarity portion 125 of the lid 120. The first polarity tab 320 (e.g., positive tab) can include a spring element 325 to apply a force at a predetermined level to the electrolyte 305. The battery cell 100 can include first polarity tab 320 (e.g., positive tab 320, a second polarity tab 320 (e.g., negative tab 320) or both a first polarity tab 320 (e.g., positive tab 320) and a second polarity tab 320 (e.g., a negative tab 320). The positive tab 320 can be disposed between a top surface of the electrolyte 305 and the lid 120. For example, the positive tab 320 can include a first end that is soldered or welded to a positive lid portion 125 and a second end that couples with a top surface of the electrolyte 305. Thus, the positive tab 320 can couple the electrolyte 305 with the positive lid portion 125 so that the lid 120 functions as a positive terminal. The positive tab 320 can be disposed within or embedded within an isolation layer 330 spacing the electrolyte 305 from the lid 120. For example, the positive tab 320 can be disposed such that it extends through the isolation layer 330 can couples the electrolyte 305 with the positive lid portion 125. The negative lid portion 130 may include a hole or aperture having an isolation layer 330 formed through the respective hole or aperture. The positive tab 320 can be disposed such that it extends through the insulated hole or insulated aperture in the negative lid portion 130 to couple the electrolyte 305 with the positive lid portion 125.

The vibration of the electrolyte 305 can be dampened within the housing 105 using the spring element 325. The spring element 325 can be embedded within the positive tab 320. The positive tab 320 can be formed having a spring element 325 formed therein. The spring element 325 can be configured to store energy, receive energy, or provide energy to elements that are in contact with the spring element 325. For example, the spring element 325 can be disposed within the positive tab 320 such that it is positioned between the electrolyte 305 and the lid 120. The spring element 325 can be positioned to receive or absorb force from the electrolyte 305 when the electrolyte 305 vibrates or otherwise moves to dampen to reduce the vibration of the electrolyte 305, such as but not limited to, during operation of an electric vehicle that includes the battery cell 100. The spring element 325 can bias or apply a force to the electrolyte 305 to prevent or dampen vibration of the electrolyte 305 when the electrolyte 305 vibrates or otherwise moves. The force can correspond to an amount the electrolyte 305 vibrates or otherwise moves. For example, the force provided by the spring element 325 to the electrolyte 305 can be the same as the amount the electrolyte 305 vibrates or otherwise moves.

The electrolyte 305 can electrically couple, through a second polarity (e.g., negative) tab 320, with the second polarity (e.g., negative) lid 130. For example, a negative tab 320 can include a first end coupled with at least one surface of a negative region or negative portion of the electrolyte 305 and a second end coupled with at least one surface of the negative lid portion 130. The negative tab 320 can be soldered or welded to at least one surface (e.g., bottom surface, side surface) of the negative lid portion 130. Thus, the negative tab 320 can extend from the negative portion of the electrolyte 305 to the surface of the negative lid portion 130. The negative tab 320 can be disposed through (e.g., through an aperture or hole) or embedded within an isolation layer 330 disposed between the electrolyte 305 and the negative lid portion 130 to couple the electrolyte 305 with the negative lid portion 130.

The negative region or negative portion of the electrolyte 305 can electrically couple, through a negative tab 320, with the housing 105. For example, a negative tab 320 can include a first end coupled with at least one surface of a negative portion of the electrolyte 305 and a second end coupled with at least one surface of the housing 105. The negative tab 320 can be soldered or welded to an inner surface of the housing 105, such as but not limited to, an inner side surface of the housing 105 or an inner bottom surface of the housing 105. Thus, the negative tab 320 can extend from the negative portion of the electrolyte 305 to an inner surface of the housing 105. For example, the negative tab 320 can extend from the negative portion of the electrolyte 305 to a side inner surface of the housing 105 or a bottom inner surface of the housing 105. The negative polarity is an example and positive polarity portions of the electrolyte can couple with the housing 105 in the same manner as the above example.

The housing 105 can electrically couple with the second polarity (e.g., negative) lid portion 130 of the lid 120. For example, the negative lid portion 130 of the lid 120 can be soldered or welded to the first end 110 of the housing 105, thus electrically coupling the housing 105 with the negative lid portion 130. The housing 105 can (in addition to the negative lid portion 130) can function as a negative terminal. The negative lid portion 130 can electrically couple, through a negative tab 320, with the housing 105. For example, via the negative tab 320, the negative lid portion 130 can electrically couple with the housing 105, which can be electrically coupled with the electrolyte 305 so that the negative lid portion 130 can function as the negative terminal for the battery cell 100. The second or negative polarity is an example and the housing 105 can be equally structurally arranged for positive polarity with a positive polarity lid portions 130 of the lid 120.

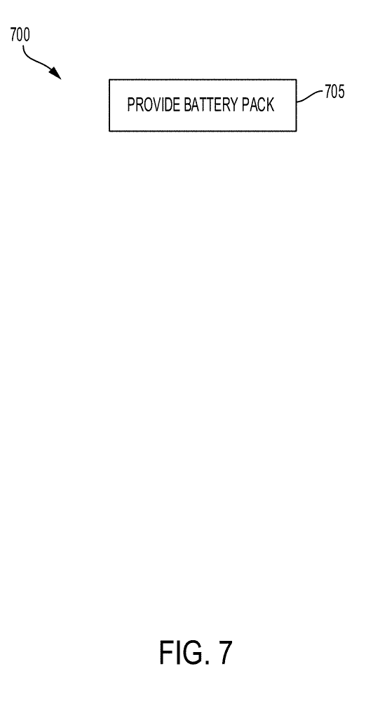

FIG. 7 depicts a method 700 of providing a battery cell 100 of a battery pack 405 for electric vehicles 505. The method 700 can include providing a battery pack 405 (ACT 705). The battery pack 405 can include at least one battery cell 100. The battery cell 100 can include a housing 105 having a first end 110 and a second end 115 and defining an inner region 310. The battery cell 100 can include a lid 120 that includes a first polarity portion 125, a second polarity portion 130 and a first isolation layer 25 between the first polarity portion 125 and the second polarity portion 130. The second polarity portion 130 can couple with the first end 110 of the housing 105. The battery cell 100 can include an electrolyte 305 disposed in the inner region 310 defined by the housing 105. The battery cell 100 can include a first polarity tab 320 that electrically couples the electrolyte 305 with the first polarity portion 125 of the lid 120. The first polarity tab 320 can include a spring element 325. The spring element 325 can applies a force to the electrolyte 305.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example the voltage across terminals of battery cells can be greater than 5V. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative polarity elements can instead be configured as positive elements and elements described as positive polarity elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A battery cell of a battery pack to power an electric vehicle, the battery cell comprising:
a housing having a first end and a second end and defining an inner region;
a lid that includes a first polarity portion, a second polarity portion and a first isolation layer between the first polarity portion and the second polarity portion, the second polarity portion coupled with the first end of the housing;
an electrolyte disposed in the inner region defined by the housing;
a first polarity tab that electrically couples the electrolyte with the first polarity portion of the lid; and
the first polarity tab including a spring element that applies a force to the electrolyte.

2. The battery cell of claim 1, wherein the spring element applies a first level of force to the electrolyte and an equal second level of force to the lid.

3. The battery cell of claim 1, wherein the spring element applies a first level of force to the electrolyte and a second level of force to the lid, the first level of force different from the second level of force.

4. The battery cell of claim 1, comprising:
the first polarity tab includes a first material; and
the spring element includes a second material, the first material different form the second material.

5. The battery cell of claim 1, comprising:
the first polarity tab includes a first material; and
the spring element includes the first material.

6. The battery cell of claim 1, comprising:
the first polarity tab is the spring element.

7. The battery cell of claim 1, comprising:
the spring element includes a plurality of inflection points; and
the plurality of inflection points form the same angle, and the angle ranges from 10 degrees to 90 degrees.

8. The battery cell of claim 1, comprising:
the spring element includes a plurality of inflection points; and
one or more of the plurality of inflection points form one or more different angle, the angle ranges from 10 degrees to 90 degrees.

9. The battery cell of claim 1, comprising:
the spring element in a first state includes a plurality of first inflections points, the plurality of first inflection points forming a first angle; and
the spring element in a second state includes a plurality of second inflections points, the plurality of second inflection points forming a second angle, the first state different from the second state, and the first angle different than the second angle.

10. The battery cell of claim 1, comprising:
the first polarity portion electrically isolated from the second polarity portion by the first isolation layer.

11. The battery cell of claim 1, comprising:
the second polarity portion welded to the first end of the housing.

12. The battery cell of claim 1, comprising:
a second polarity tab that electrically couples the second polarity portion with the housing.

13. The battery cell of claim 1, comprising:
a second polarity tab that electrically couples the housing with a negative region of the electrolyte.

14. The battery cell of claim 1, wherein the spring element dampens vibration of the electrolyte within the housing.

15. The battery cell of claim 1, comprising:
a second isolation layer disposed between the electrolyte and the second polarity portion of the lid.

16. The battery cell of claim 1, comprising:
the battery cell disposed in a battery pack having multiple battery cells, the first polarity portion forming a positive terminal for the battery cell to couple with the battery pack and the second polarity portion forming a negative terminal for the battery cell to couple with the battery pack.

17. The battery cell of claim 1, comprising:
the battery cell disposed in a battery pack and the battery pack disposed in an electric vehicle.

18. A method of providing electrical power to electric vehicles via battery cells of a battery packs, comprising:
providing a battery pack having a battery cell, the battery call having a housing that includes a first end and a second end and defining an inner region;
disposing an electrolyte in the inner region defined by the housing;
coupling a lid to the first end of the housing, the lid including a first polarity portion, a second polarity portion and a first isolation layer disposed between the first polarity portion and the second polarity portion, the second polarity portion coupled with the first end of the housing; and
electrically coupling, through a first polarity tab, the electrolyte with the first polarity portion of the lid, the first polarity tab including a spring element to apply a force at a predetermined level to the electrolyte.

19. The method of claim 18, comprising:
dampening vibration of the electrolyte within the housing using the spring element.

20. An electric vehicle, comprising:
a battery cell of a battery pack to power an electric vehicle comprising, the battery cell comprising:
a housing having a first end and a second end and defining an inner region;
a lid that includes a first polarity portion, a second polarity portion and a first isolation layer between the first polarity portion and the second polarity portion, the second polarity portion coupled with the first end of the housing;
an electrolyte disposed in the inner region defined by the housing;
a first polarity tab that electrically couples the electrolyte with the first polarity portion of the lid; and
the first polarity tab including a spring element that applies a force at a predetermined level to the electrolyte.
